(19) United States
(12) Patent Application Publication
(10) Pub. No.: US 2003/0149958 A1
(43) Pub. Date: Aug. 7, 2003

(54) Automatic code generation for applications which run on common platforms

(76) Inventors: Shumeet Baluja, Los Angeles, CA (US); Eric Wilson, Brentwood, CA (US); Suddhasattwa Bose, Venice, CA (US); Hyosung Han, Redondo Beach, CA (US)

Correspondence Address: CRAIG A. GELFOUND, McDERMOTT, WILL & EMERY, 2049 CENTURY PARK EAST, 34TH FLOOR, LOS ANGELES, CA, 90067, US

(21) Appl. No.: 10/157,312

(22) Filed: May 28, 2002

Related U.S. Application Data
(60) Provisional application No. 60/354,817, filed on Feb. 6, 2002.

(51) Int. Cl. G06F 9/44

(52) U.S. Cl. 717/106

(57) ABSTRACT

A method of automated code generation. The method includes identifying an event related to the execution of an application, generating code related to the event using an automated process, and integrating the code into the application. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### CROSS-REFERENCE TO RELATED APPLICATIONS

The present application claims priority under 35 U.S.C. §119(e) to provisional Application Serial No. 60/354,817, filed Feb. 6, 2002, the contents of which are incorporated herein by reference.

### FIELD

The present invention relates to automatic code generation, and more specifically, to the automatic code generation for applications which run on common platforms, such as wireless communication devices.

### BACKGROUND

The amount of storage for electronic devices continues to increase. As more storage becomes available more applications can be added to electronic devices. For example, in portable communication devices, such as cellular phones, an increasing number of applications that include wireless data are being developed and used. Additionally as memory density increases, more memory can be included in portable communication devices. As the amount of memory available on portable devices increases, the number of applications that can be accommodated in wireless devices increases. As the number of applications available for portable devices continues to increase, more is invested in the creation of such applications. Additionally, because more storage area is becoming available, the size of such applications also tends to increase as does the number of features available for each application. As investments in such applications increase, the performance of such applications becomes more and more critical, and the potential for such applications interfering with each other's performance increases.

Additionally as the storage available in electronic devices, such as wireless communication devices, increases the number of applications that can be included in such devices increases. Such applications may be created by different organizations, and in a variety of programming languages. When multiple applications are resident in a single electronic device, it is desirable that such multiple applications cooperate, particularly when such applications use common resources. Without such orchestrated cooperation, i.e. the harmonizing of the applications, the functioning of multiple applications may interfere with each other by, for example, demanding access to a single resource simultaneously, attempting to write to the same address concurrently or overwriting each others data. Such problems are readily illustrated in the case of multiple applications within an electronic communication device, that must share not only the same computing space, but the same resources such as, a radio transceiver.

### SUMMARY

In one aspect of the present invention, a method of automated code generation includes identifying an event related to the execution of an application, generating code related to the event using an automated process, and integrating the code into the application.

In another aspect of the present invention, computer readable media embodying a program of instructions executable by a computer performs a method automated code generation, the method including receiving an event related to the execution of an application, and generating code related to the event using an automated process for integration into the application.

In yet another aspect of the present invention, a system for automatic code generation including event identifier means for identifying an event related to the execution of an application, code generation means for generating code related to the event using an automated process, and code integration means for integrating the code into the application.

It is understood that additional aspects of the present invention and variations thereof will become readily apparent to those skilled in the art from the following detailed description. The following descriptions illustrate and describe exemplary embodiments of the invention, simply by way of illustration. As will be realized, the invention is capable of other and different embodiments, and its several details are capable of modifications in various respects, all without departing from the scope of the disclosed invention. Accordingly, the drawings and description are to be regarded as illustrative in nature, and not as confining the inventive concepts to the illustrations disclosed.

### BRIEF DESCRIPTION OF THE DRAWINGS

Aspects of the present invention are illustrated by way of example, and not by way of limitation, in the accompanying drawings in which like reference numerals refer to similar elements throughout:

FIG. 1 is a graphical illustration of an environment in which embodiments of the invention may be used.

FIG. 2 is a graphical illustration of the handling of requests for data and replies, from aportable communication system.

FIG. 3 is a graphical illustration of application event logging in a portable communications device, exemplarily a cell phone.

FIG. 4A is a graphical illustration of application event logging in a portable communications device.

FIG. 4B is another graphical illustration of application event logging in a portable communications device.

FIG. 4C is yet another graphical illustration of application event logging in a portable communications device.

FIG. 5 is a graphical illustration of the use of the automatically generated code for two applications.

FIG. 6A is a flow diagram illustrating the process by which a supplier of event monitoring code provides target code to a user.

FIG. 6B is a flow diagram illustrating the process by which a user of event monitoring code receives target code from a supplier.

FIG. 7 is a graphical illustration of an exemplary application developer—code provider arrangement, according to an embodiment of the invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well known structures and devices are shown in block diagram form in order to avoid obscuring the concepts of the present invention.

In an exemplary embodiment of a communications system, data logging or tracking code is generated to monitor a resident application. The data or tracking logging code is included in the resident application code. Applications that use common resources, such as the illustrative tracking or data logging code, may be harmonized so that multiple applications can cooperatively interact and thereby operate in an efficient manner, without interfering with one another. Such data logging may be accomplished transparently to the user, by code generated for the application developer. Such code may be generated in a variety of languages so that application developers may utilize the code generated without having to accommodate code in a language different than used in their application.

Various aspects of automatic code generation will be explained and advantages illustrated by an example in which data logging for multiple applications will be described in the context of a cell phone communication system, however, those skilled in the art will appreciate that the inventive aspects of automatic code generation, illustrated herein in terms of generating data logging code for communication devices, may be applied to code generation for a variety of applications. Accordingly, the references to the automatic generation of code for data logging of applications in cellular communications are intended only to illustrate the inventive aspects of the present invention, with the understanding that such inventive aspects have a wide range of applications in other electronic devices. The disclosure of inventive concepts herein is merely facilitated by such a concrete example, those skilled in the art will recognize that the inventive concepts disclosed herein are in no way limited to the exemplary embodiments disclosed.

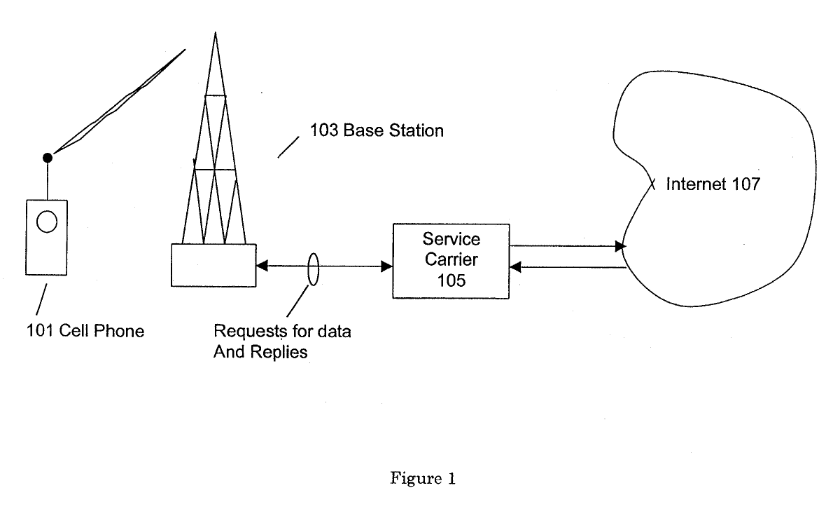

FIG. 1 is a graphical illustration of an exemplary communications system. In FIG. 1 an exemplary cellular telephone 101 communicates with a base station 103. The data communications between the cellular telephone 101 and the base station 103 include requests for data, which are transmitted from the cellular telephone 101, and replies, which provide data to the cellular telephone 101 from the base station 103. Commonly, the cellular telephone 101 communicates with the base station 103, which is in its cellular area. As the cellular telephone 101 moves to another cellular area, the cellular telephone 101 will commonly communicate with another base station (not shown). The requests for data are relayed by the base station 103 to a service carrier 105. The data link between the base station 103 and the service carrier 105 may be any type of link known in the art, for example a telephone line conductor, a microwave link or fiberoptic link. The service carrier 105 provides replies to requests for data from the base station 103. The base station 103 in turn communicates the requested data to the cellular telephone 101. The service carrier 105 communicates with a source of data, such as the Internet 107. The use of the Internet as a source of data is used for the purpose of illustration only and other repositories of data could be equivalently substituted.

Additionally, the service carrier 105 is not limited to communications with a single data source, such as the Internet 107 shown. The service carrier 105 may communicate with additional sources of data, for example optical storage, raid (redundant array of inexpensive disks) storage or other data sources well known in the art.

Requests for data and replies may be of various forms. For example, the cellular telephone 101 may request a download of data in order to play a game on the cellular telephone 101. The data request may also be gaming parameters interchanged between the cellular telephone 101 and remote users who are playing against, or in cooperation with the cellular telephone 101 user. In such a way, interactive games can be played by a variety of users in a large geographical area. Another example of an application that may be used within the cellular telephone 101 is that of a stock quote application. The cellular telephone user can communicate with a website, which may send the cellular telephone stock quotes, price alerts, trends, etc. Many different types of applications may be contained in the cellular telephone 101. With the appearance of cellular telephones containing web browsers, virtually any type of Internet application can be accessed. Generally, it is desirable to analyze the trends in this type of application to improve those applications. It is also desirable that such applications be able to cooperate in an orderly fashion so that the functioning of one application does not compromise the functioning of another. One way to help insure cooperation among applications is to secure segments of code, which interact with common resources in the communication device, from one source (or multiple sources which operate under harmonized rules). Such a source of harmonized code that may be used in multiple applications sharing common resources is designated herein as a “code provider.”

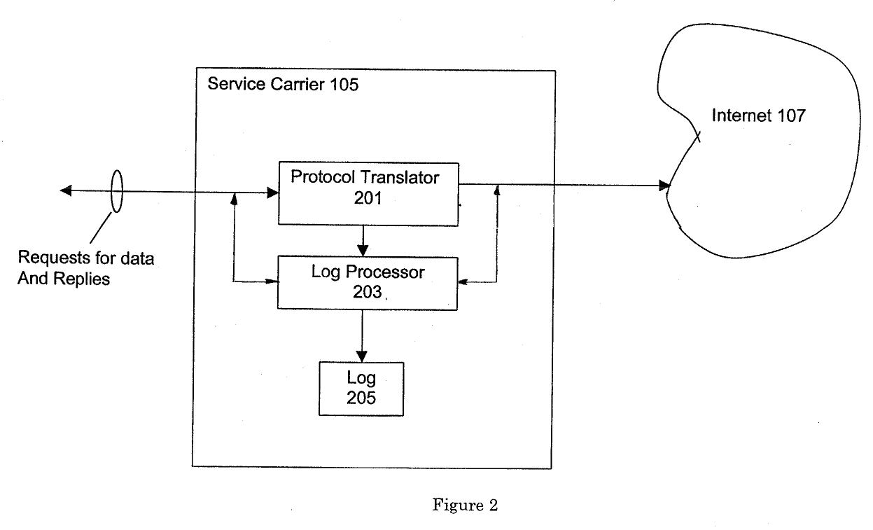

FIG. 2 is a graphical representation illustrating an exemplary technique to produce a data log 205 of traffic between the base station 103 and the cellular telephone 101. In FIG. 2 the service carrier 105 accepts the requests for data and provides replies. The requests for data are translated in a protocol translator 201, which translates the requests for data into a protocol which may be recognized by the data provider such as the Internet 107. The protocol translator 201 also accepts the communications from the data provider such as the Internet 107 and translates it into an appropriate form to be further transmitted to the base station 103 and further transmitted to the cellular telephone 101. A log processor 203 may log the requests for data to and from the cellular telephone 101 in the data log 205. The protocol translator is optional—data can be forwarded directly without any change in the protocol. In either case, the logging is done by monitoring the communication that occurs at the service provider between the cellular telephone 101 (or any device to be monitored) and the Internet (or any data source).”

If an application is downloaded to the cellular telephone 101, it is useful to know how effective that application is. Application designers may wish to know the answers to questions such as: Is the application performing as the user expects it? If the application provides its own requests for data, are the requests timely? What kind of response time does the application provide? How extensive is the use of the application? What parts of the application are most frequently used? Which parts of the application are hardly ever used? How often is the application used? What is the duration of use of the application? What is the time of use per hour, day, week, month, etc.? A data log resident within the cellular telephone 101 may provide much of this type of information. Such an improved log can provide not only simple counting functions, such as numbers representing the peak number of requests, average length of requests and so forth, but may provide additional information with regard to the use of data within the cellular telephone 101.

This concept can be extended to generate log entries based on billable events. For example, an application designer may wish to charge specialized fees for significant events that occur during game use. Examples of specialized fees as they relate to significant events in a game could be: use of particular game features, “weapons” or attributes about the game. The application designer may also choose to award players monetary or other incentives for achieving a high score or playing the game for a certain amount of time. Or the application designer may wish to charge for the game based upon the amount and type of usage. A golf game designer may wish to bill based on the courses that are played. All aspects of usage can be recorded in the data log and transferred back to a collection system with the rest of the recorded event data. From the usage logs, billing events can be extracted and used to generate billing statements. In general, all events related to usage, whether for improving the application, monitoring the application or billing for use of the application can be logged into single or multiple client-side data logs. When the data logs are gathered and processed, whether on the device or at a service provider or at a third party, these events can be forwarded to their respective destinations.

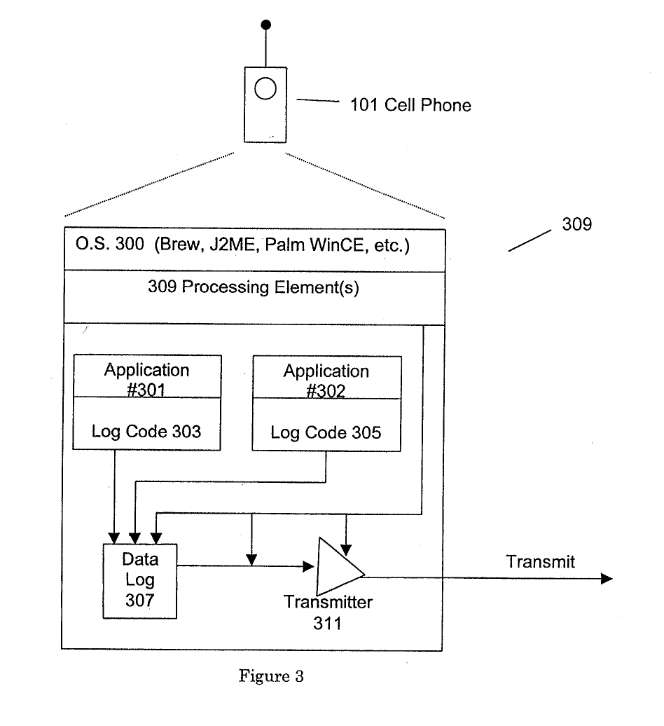

FIG. 3 is a graphical illustration of application event logging in a portable communications device, such as the exemplary cellular telephone 101. In FIG. 3, the inner workings of the cellular telephone 101 are graphically illustrated at 309. The cellular telephone 101 may have an operating system 300 in order to manage the electronic functions of the cellular telephone 101. A variety of operating systems may be used, such as for example the palm operating system, the Windows CE operating system, the Brew operating system (binary run time environment for wireless), the J2ME (JAVA-2 Platform Micro Edition) operating system, and the like. The operating system 300 or application execution environment, may provide resources and coordination for the applications which are executing within the cellular telephone 101, such as application 301 and application 302. There may be multiple applications within the cellular telephone 101 and multiple applications may be executing or lying dormant waiting for an event.

The applications are commonly executed by one or more processing elements 309 such as microcontrollers, sequencer circuits, state machines or the like. Each application within the cellular telephone 101 contains log code. Application 301 contains log code 303. Application 302 contains log code 305. Each of the applications uses its log code to write event data to a data log 307. The term “data log” refers to a portion of memory dedicated to recording events for one or more applications. The cellular telephone 101 may be implemented with a single data log which is shared between one or more applications as shown in FIG. 3, or alternatively, each application can have its own data log. Multiple data logs can be implemented by reserving portions of a single memory device for each data log, or alternatively, one or more of the data logs can be implemented on separate memory devices. For multiple data log implementations, a process resident in the operating system may be used to aggregate the data logs asynchronously at a later time, or the data logs may be aggregated at a time after they are transmitted to a different device. Writing to the data log 307 may be controlled by functions of the operating system 300 or application execution environment, directly, or indirectly by the log code within each application. Before being written to the data log 307, the data may be compressed by any algorithm known in the art to conserve memory resources. The log code within each application should be harmonized, that is designed so as not to interfere with the log code from another application. That is, the log code should be so constructed such that data logged by one application will not be corrupted by data logged by another application.

The data for the data log 307 can be transmitted to the base station 103 and then provided to application developers, the service carrier 105 or whomever has an interest in such data. The data log 307 may contain data written by multiple applications.

In the illustration of FIG. 3, the data log 307 may contain data requests, but may also contain any information desired regarding the functioning of the applications, and about the user's interaction with the application. For example, if the user had requested the download of a golf game, the types of golf clubs used, the number of holes played in the golf game, the time of day the game is played, and the duration of play might be logged for use in providing feedback to the golf game designer. In another example, the data may be which stocks are most commonly traded or which sports scores are most commonly requested. Further data may be collected on what times of day applications are used.

Once the data log 307 has been written, it may be transmitted to the base station 103, using a transmitter 311, and later provided to those interested in such data. Various modes of transmission are possible. A first mode of transmission is when a portable communications device, such as the cellular telephone 101, initiates its own communications to transmit the data from the data log 307. Such a scheme could be triggered by the data log filling to a certain point thereby causing the cellular telephone 101 to initiate the call to download the data from the data log 307. Such a method is simple and straightforward, however, there is no guarantee that the data can be transmitted once the data log 307 is filled to a certain level. Accordingly, to keep the data log 307 from overflowing, the level of the data log 307 which initiates a transmission may have to be unacceptably low, and therefore, the data log may need to transmit more frequently. Additionally, the user of the cellular telephone 101 wishing to use it for other purposes such as, for example, placing a telephone call may interrupt such transmissions.

Another mode of transmitting data from the data log 307 is to transmit data in response to a trigger such as the occurrence of an event. For example, the data can be transmitted from the data log 307 every time the application is started or when a particular event occurs during the execution of the application. Alternatively, the data could be transmitted from the data log in response to a request from the base station 103.

Alternatively, the data from the data log 307 can be transmitted opportunistically. That is to include data, from the data log 307, in a transmission originated for another purpose. For example, in every communications between the cellular telephone 101 and the base station 103, a portion of the bandwidth, though allotted to that communications, remains unused. The unused bandwidth could be used to transmit the data from the data log 307. For example, in a digital type cellular telephone, the voice conversations are commonly converted into digital data, packetized and transmitted in packet form. Such a transmission may be initiated by the processing element 309 activating the transmitter 311. If bandwidth is allocated to communicate to and from the cellular telephone 101, then that bandwidth is allotted to the cellular telephone 101 whether any telephone conversation is being transmitted back and forth or not. In other words, whether any data is transmitted back and forth the same amount of bandwidth may be reserved for use by the cellular telephone 101. The data from the data log 307 may be transmitted using the transmitter 311 every time that space becomes available in the bandwidth, that is when the cellular telephone 101 is not being used to communicate. Since the allocation of transmission bandwidth is known to the processing element 309, the processing element 309 can intersperse the data from the data log 307, with the data being transmitted to convey the telephone conversation, and both may be transmitted by transmitter 311, without interfering with the telephone conversation. There are commonly, multiple transmission opportunities when the cellular telephone 101 is used to place a call as data packets can be transmitted between spoken words and while data is being received. Such an opportunistic transmission also has an advantage in that it may not consume additional bandwidth to transmit the data, rather it may use the bandwidth which otherwise would remain unused and wasted. Additionally, because the use of the cellular telephone is likely to be quite frequent, the data log 307 may continually be emptied opportunistically thereby reducing the chance of having an overflow condition in which the memory allotted to the data log 307 is inadequate.

Piggybacking data on other data or voice communications transmissions may also be used to opportunistically transmit data in other applications as well. By transmitting whatever data is available whenever a transmission takes place, the reporting from the data log 307 may be made transparent to the user. Additionally, by piggybacking data on other transmissions, no call needs to be initiated. The amount of data piggybacked can be limited so that it only forms a small portion of the transmission.

A further advantage of data log 307 is that it may log events from the application, which are not related to requests for data. For example, if the application is a stock pricing programmed by the cellular telephone user, the behavior of the user and inputs to that application may be logged. For example, the average number of keystrokes per activations (and what those keystrokes were) could be logged in order to determine more efficient user interfaces. Such logging may be transparent to the user of the application. That is the user of the application need not know that the log is being generated and the log will not interfere with the user's use of the application. Alternatively, the user may consent to taking part in such a user application study. Additionally, by utilizing opportunistic transmission from the data log 307 there will not be an additional cost or air time being attributed to the user. Opportunistic transmission can occur whenever a transmission is initiated to transmit for a purpose not related to the data log 307. Once the transmission is initiated data from the data log 307 may be piggybacked on the already initiated transmission. By having the log code resident as part of each application (e.g. 303), logging can be done completely transparently as can the data transmission.

The log code 303 may be included along with each application that is downloaded to the cellular telephone 101. Additionally, any application, which is resident in the cellular telephone 101, may come equipped with such logging code. Such logging code can provide application developers with valuable information on how their application is used, and therefore, how they may improve it. Additionally, by having cooperating log code with each application, an uncorrupted log 307 may be generated. As an alternative to embedding the logging code in each application, the logging code may be incorporated as a part of the operating system 300 or application execution environment. The data log 307 in turn may be created and managed by the operating system 300, or the application execution environment, or by the cooperative use of logging code among applications. If the data log 307 were created by an operating system, or application execution environment, then the data log 307 could be used by any resident or downloaded application. If the data log was 307 not a part of an operating system, or application execution environment, function then it might be created by the first application to require its use. Put in other words, the first application to have the logging code could detect that no data log had been created and create data log 307. In operating systems, or application execution environments, that allow the sharing of resources, subsequent applications would not need to create the data log 307, they could detect that the data log 307 had already been created. Applications may write to the data log 307 and not corrupt each other's data logging by using software techniques, such as the locking of the data log 307, well known in the art. In some embodiments, the application can detect when the data log is locked and create a second data log for recording events during that period. This concept can also be extended to situations where the application is transmitting data from the first data log opportunistically, or otherwise, but needs to continue to monitor certain events. In this case, a second data log can be created for that purpose.

A code provider may provide the cooperating code for an application that is permanent, or transient—for example part of a downloaded application to be deleted when it is no longer used, or part of the operating system, or a hybrid encompassing several different types of code. Because the code provider is aware of the uses of the application code that it is providing for a platform, the code provider can assure that the applications are harmonized and work cooperatively together on that platform. In addition, the application provider can reap the benefits of tracking application usage and performance without creating extra synchronization, logging, or transmission code into its application. The code provider has effectively eliminated the cumbersome task of creating additional code and designing a reporting system by the application provider making the logging and usage gathering fast, simple and uniform for the application providers.

Because a code provider may only be providing code for the portion of the applications that use common resources the remainder of the application developer's program can remain secret and proprietary to the application developer. The application developer only needs to specify its use of the common resources and the language it will be using, for example saying to the code provider “I wish to store usage data, related to a number of events in my application, in the data log 307 in the cellular telephone 101, and I want you (the code developer) to handle everything from synchronizing with other applications and delivering the data to the main data gathering repository. My program is written in C. Because the application developer only provides the code provider with requests for code that uses common resources, the application developer is free to keep the rest of their code proprietary and secret, and yet know that it will function without interference from or interfering with other applications that use the same resources. The application developer is also free to develop in any language that the code provider supports. As a result, the application provider does not need to account for all the ways in which the other applications may be using the logging procedures. In addition, the application provider does not need to be concerned about which applications are using the logging procedures and when this is occurring.

Additionally, the requests to log data made by the applications could be stored in the data log 307, thereby eliminating the need for the data log 205 at the service carrier 105 such as illustrated in FIG. 2. Because each cellular telephone could maintain its own data log, the need for some of the processing of the data log searching through the data log 205 at the service carrier 105 for data related to one user may be mitigated. When such data is transmitted, it may be appended to previously transmitted data from the same cellular telephone if desired. In such a way, a particular user's data log could be generated as the logging is done. Techniques for linking data using a variety of criteria, such as by user, type of application and so forth are well established in the art.

In order to discern patterns within the data log 205 in FIG. 2, the data log 205 may be searched. In contrast, data transmitted from cellular telephones may already contain aggregate data thereby eliminating the more time consuming process of searching and sorting through the data log 205 at the service carrier. When data is transmitted from the data log 307, it could be already aggregated by cellular telephone user, by application, by time of day, or any other conceivable criteria desired before being transmitted. By building up a database prior to transmission of the data, user trends may be identified and use of computer resources to search and sort through a log database such as the data log illustrated at 205 at the service carrier 105 could be, at least partially, avoided. Additionally, the data from the data log 307 could be communicated to the end user application as it was transmitted.

In addition, the data log could be deleted when no longer required. The trigger to delete the data log could be initiated by the application that requested an event to be logged, the operating system or the application environment, or could be automatically triggered based on the successful completion of the send-log-event.

If the logging code and data log were functions provided by the operating systems 300, or application execution environment, each application would only need contained calls to the proper API (application programming interface) in order to log the data event. To the extent the APIs reside in the operating system or application execution environment, the size of each application's code can be reduced.

An additional advantage of including logging code within an application is that when the application is improved the logging code included with the application may also be changed. For example, if a user downloads a game, the use of the game may be monitored through the use of logging code and the data log as previously described. Once the data from multiple users has been used to improve the game, a new version with new logging code may be downloaded and used to monitor the use of the new version of the game. The same principle applies to any application which may be used within the cellular telephone or any portable communications device. In such a way applications may be monitored and continually improved. Alternatively, the logging code itself may be an application. Other applications may call the logging code application during their execution. In the case where the logging code were implemented as an application, the logging code could be updated without having to affect the operating system, or application execution environment, code 300.

An additional advantage provided by the use of a code provider is that no matter what type of code is provided, permanent code, transient code that is deleted when an application is deleted, operating system code, or any other category of code, which involves the use of common resources, may be provided by the code provider. In such a way the code accessing the common resources could be made to cooperate even in the case where multiple vendors were providing proprietary applications.

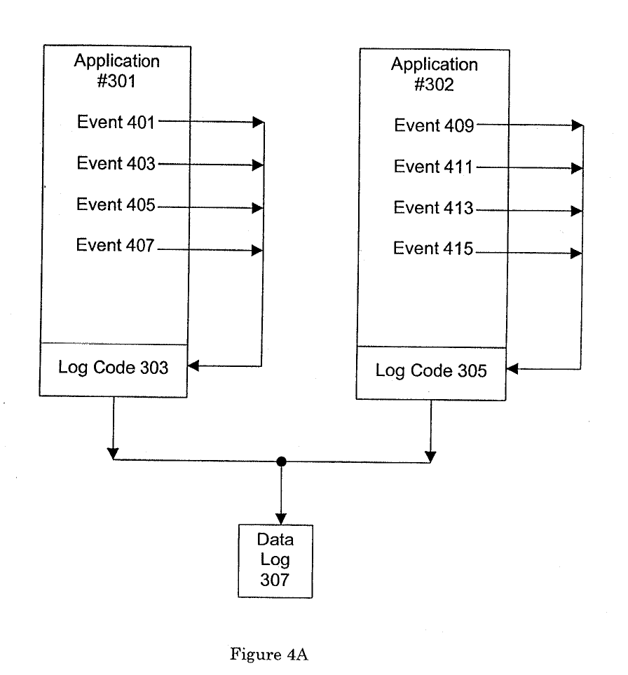

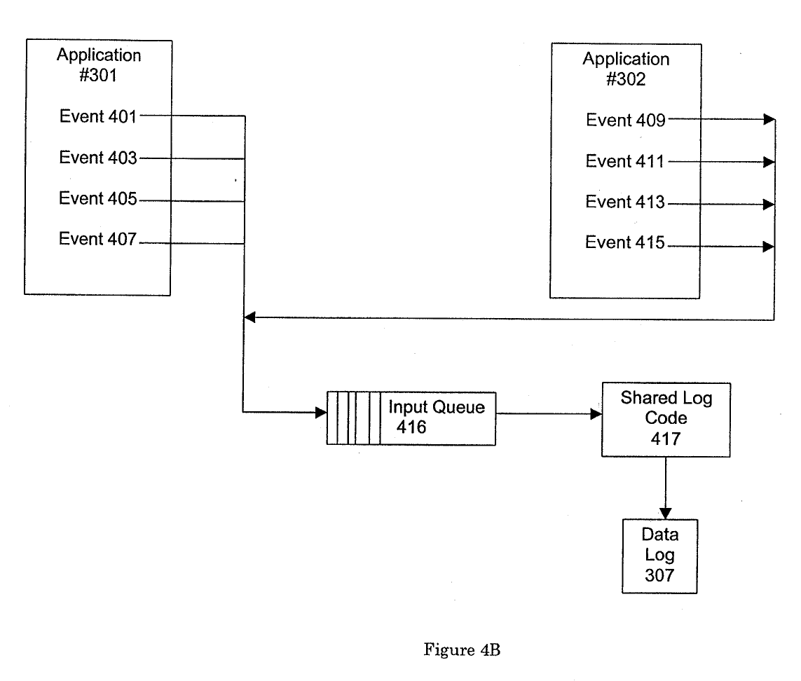

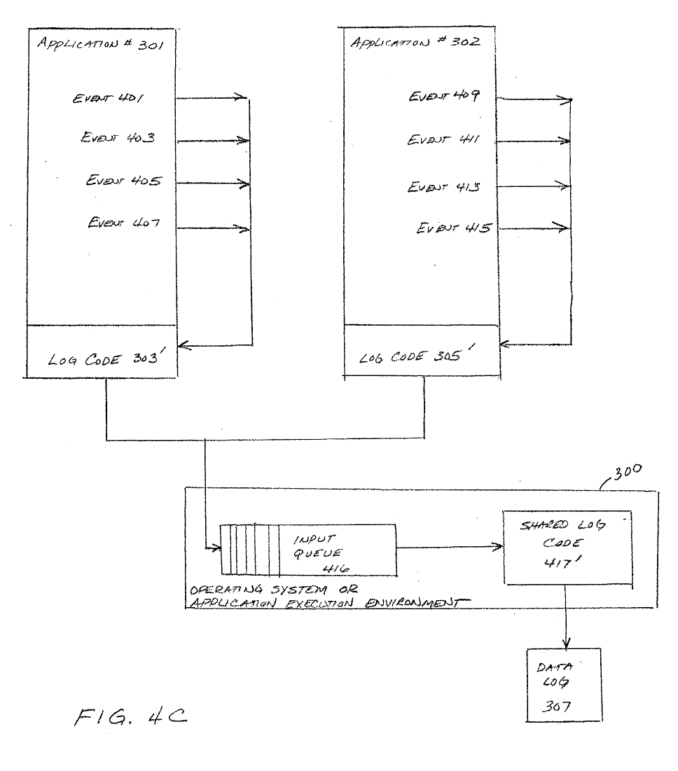

FIG. 4A is a graphical illustration of an application event logging technique in a portable communications device. In FIG. 4A the application 301 includes four events 401, 403, 405 and 407 which are software events, the occurrence of which is desired to be logged. Similarly, the application 302 has four events 409, 411, 413 and 415 desired to be logged . The occurrence of event 401 becomes a logical trigger for the log code 303 to write into data log 307. Similarly, each of events 401, 403, 405 and 407 become a logical trigger for the log code to write the occurrence of the event within data log 307. Log code 303 can be tailored as desired. For example, if event 401 is the start of the use of application 301 and event 407 is the termination of application 301, log code may contain the times that the event 401 and event 407 occurred, for example by retrieving the time from the operating system 300, or application execution environment. Similarly, if event 403 is a request for a stock quote, then log code 303 may only record the number of times that the event has occurred. In such a way, any type of event can be tracked. The parameters of an event can be defined and the logging code to accommodate the recordation of that particular event defined. The writing to the data log 307 may be controlled by cooperative multi-tasking between applications using various techniques that are well known in the art. Additionally, applications may request access to the data log 307 through an operating system, or application execution environment, such as one described in connection with FIG. 3. In such a way, the data log 307 can be prevented from being corrupted by the log codes such as 303 and 305 writing simultaneously to the same area in the data log 307. Alternatively, each application may have its own data log. In such a case, the data log may be a dynamic memory element in which memory is allocated as needed. In such a case, the log code of each application may still cooperate in drawing memory as needed from a common pool.

FIG. 4B is a graphical illustration of an alternative application event logging technique in a portable communications device. In FIG. 4B, the events from each of the applications, i.e., the application 301 and the application 302 do not have their own data logging code. Instead the application 301 and the application 302 utilize a shared log code 417. Depending on the rapidity of the events 401 through 415, the shared log code may need an input queue in order to temporarily store events prior to the shared log code 417 writing the events into the data log 307. The input queue 416 may exist in order to manipulate the events so that they may be compressed in order to take up the least amount of space in the data log 307. The queue may be a dynamic type queue so that it does not permanently impact the amount of storage available overall. In embodiments without an input queue, the applications 301 and 302 can directly access the shared log code 417.

FIG. 4C is a graphical illustration of yet another application event logging technique. In FIG. 4C, each application 301 and 302 can have its own log code 303′ and 305′ that interfaces with code 417′ that may be resident on the operating system 300 or application execution environment. With this approach, the process of writing to the data log 307 is shared between the code for the particular application and the code in the operating system or application execution environment.

Alternatively each of the events may have its own logging code. In such a case the need for the log code 303, and the log code 305 may be eliminated. However it is likely that sharing portions of the log code among the events, which will be logged in an application, will result in a saving of application size. Similarly instead of each application having its own log code, the shared log code 417 may accomplish the same purpose as shown in FIG. 4B.

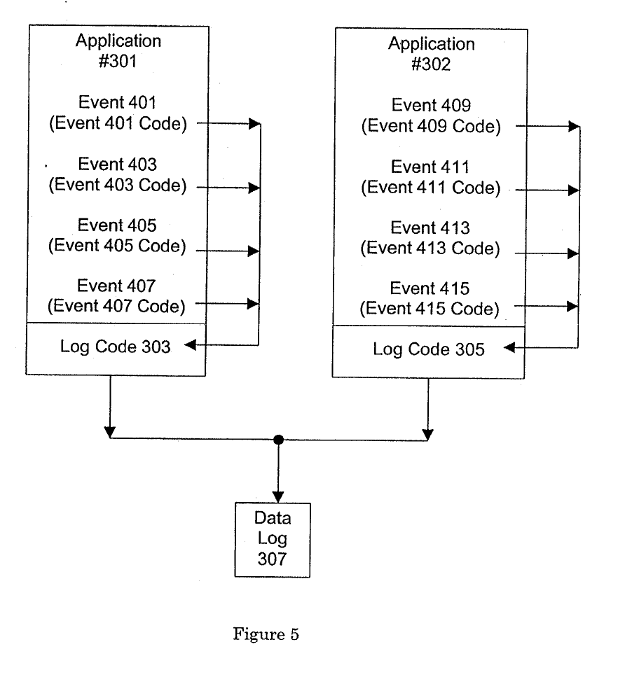

FIG. 5 is a graphical illustration of the automatic generation of code for two applications. The developer of the application 301, designated as the application developer (or developer) A, wishes to log the occurrence of the events 401, 402, 403 and 405. The application developer (or developer) of the application 302, designated as the developer B, wishes to log the occurrence of the events 409, 411, 413 and 415. The developers may use a variety of computer languages for developing their code. For example, computer languages such as “C”, Java, assembly language, C++, HTML, PLM, Pascal, Basic and a variety of others have been used for application code development. The developer A uses a first computer language to develop his code, whereas the developer B uses a second computer language to develop his code. Both of the developers will use the same data log 307 and the same transmitter 311.

For the sake of simplification of the disclosure it will be assumed that the logging code will be provided by the code provider, designated as C, to the application developer A and the application developer B. Further, for the sake of simplicity it will be assumed that the interaction between the code provider C and the application developers A and B will take place over the Internet. In actuality the interaction between the code provider C and the application developers A and B make take any form convenient to them. The application developers A and B may provide their requests for code in any form, and likewise code provider C may provide the resultant code to the application developers in any form desired, and any language desired. Further assume that the code developed to be inserted in an application program will be denoted as target code, and the application in which the target code will be inserted is the target application. The language of the target code will be designated as the target language. Although the application developers are identified separately for the sake of clarity, those skilled in the art will realize that a code provider may also be an application developer. The distinctions of code provider and application developer are intended for the purpose of illustration and simplification and no limitation is intended, as variations of the roles of the application developer and the code provider are likely. For example, all the application developers and code providers may be part of the same organization or even different functions for the same individual.

For illustration purposes, the application developer A is the developer of the application 301, and the application developer B is the developer of the application B. The application developer A provides the events 401, 403, 405 and 407 to the code provider C. The events 401, 403, 405 and 407 may be any sort of event that the developer A wishes to track, such as (but not limited to), updating of a variable, activation of particular code, receiving of a particular input, timing of events and so forth. The developer A may choose to track any type of event which may be perceived from the application 301. So, for example, the developer A provides the events 401, 403, 405 and 407 to the code provider C. The code provider C then provides the event codes 401, 403, 405 and 407 to the developer A to insert into the application 301. The code provider C also provides the log code 303 for the developer A to insert into the application 301. The log code 303 may receive notification of the events 401, 403, 405 and 407 from the event codes 401, 403, 405 and 407 and record the events in the data log 307. The log code 303 may also create the data log 307 if it does not exist.

Similarly, the developer B provides the events 409, 411, 413 and 415 to code provider C. The events 409, 411, 413 and 415 may be any type of event that the developer B wishes to track. The developer B, just as the developer A, may choose to track any type of event which may be perceived from the application 302. So, for example, the developer B provides the events 409, 411, 413 and 415 to the code provider C. The code provider C then provides the event codes 409, 411, 413 and 415 to the developer B to insert into the application 302. The code provider C also provides the log code 305 for the developer B to insert into the application 301. The log code 305 may receive notification of the events 409, 411, 413 and 415 from the event codes 409, 411, 413 and 415 and record the events in the data log 307. The log code 305 may also create the data log 307 if it does not exist.

Because the log code 303 and the log code 305 come from code provider C they may be made to cooperate, for example, the data log 307 may be locked and unlocked, through software techniques well known in the art, to prevent the log code 303 from corrupting the data written, or partially written, by the log code 305. Additionally the code provider C may provide the target code to the developers in any language that the developers select. In such a way the multiple application developers may create routines for their applications that run on a common platform. The code provider C, which provides target code that accesses common resources or runs on a common platform, may thereby insure that the target code provided to one application developer will not interfere with target code provided to another application developer.

C is also responsible for ensuring that all the events are unique and are associated correctly with each application. Additionally, it is C's responsibility for ensuring that the applications work together and that they do not overwrite each other's logs regardless of whether C has written code into the operating system or application execution environment or inserted code into each individual application, and regardless of whether the applications write to primary or backup files, or whether each application writes to the same logs or to separate logs that are later merged at some stage.

The code provider C has many options of how to automatically generate the code for the developers A and B. A sample process may be to have a series of templatized functions that are automatically customized based upon the requested events to be tracked. One such exemplary function is shown below. A general function that the code provider C may have written would take the form as follows (the #variable represents variables that are passed into a function; for clarity, variables types are also shown)

| | |
|---|---|
| General_Log_Event | (#NAME_OF_DEVELOPER: |
| | alphabet_characters, |
| | #NAME_OF_APPLICATION: |
| | alphabet_characters, |
| | #EVENT_IDENTIFIER: integer, |
| | #EVENT_VALUE: alphabet_characters) |
| | {Logging & synchronization code here} |

In this example, the developer A has developed a golf game and wishes to have code to track which golf club is used. The developer A only has to specify the name of the event (for example “Which—Golf—Club”), and the name of the application (“My—Golf—Game”). At that point, the code provider C can generate code that is easy for the Developer A to use and has the following form.

Log—Which—Golf—Club (#EVENT—VALUE: alphabet—characters);

Now, to log the use of which golf club is used, the developer A only needs to add a call into its program that calls the above function. Such a call could take the following form:

Log—Which—Golf—Club (“5 iron”);

Note that this function only takes one parameter, instead of the four that are required to the General—Log—Event function. This makes it easier to use for the developer A and is less susceptible to errors.

The above code can be generated with the General—Log—Event function serving as a template from which other more specific functions can be automatically generated. In particular, the Log—Which—Golf—Club function can be implemented as a wrapper that calls the General—Log—Event function. For example, as follows:

Log—Which—Golf—Club (#EVENT—VALUE: integer)

{This code simply calls the following function:

General—Log—Event (“Developer A”,

“My—Golf—Game”,

94812,

EVENT—VALUE)}

Here, 94812 is a sample event identifier that the code provider C has specified for use for this event. Note that because the code provider C controls which event identifiers are used, the code provider C can ensure their uniqueness.

Note that the rest of the code (for example the General—Log—Event) may also be shipped to the developer A. However, the developer A will not need to use this directly, as specialized functions have been created (i.e. Log—Which—Golf—Club) to handle its logging needs. Alternatively, the code for General—Log—Event may be directly integrated into Log—Which—Golf—Club thereby eliminating the need to submit General—Log—Event as separate code altogether. Also note that the body of the function General—Log—Event may not need to change, or can be changed in a manner exactly similar to the method described here, by viewing it as a template.

The extent to which the code is customized is an implementation detail. For example, it may be possible to create functions that already have the name of the developer and the application ID filled in, but still require the developer to insert the event identifier etc.

In cellular telephones in which some code resides in the operating system, application execution environment, a similar methodology can be used to generate the remainder of the code to be integrated into the application. Returning to the example given earlier: If the function:

| | |
|---|---|
| General_Log_Event | (#NAME_OF_DEVELOPER: |
| | alphabet_characters, |
| | #NAME_OF_APPLICATION: |
| | alphabet_characters, |
| | #EVENT_IDENTIFIER: integer, |
| | #EVENT_VALUE: alphabet_characters) |
| | {Logging & synchronization code here} |

is already on the cellular telephone, for example, either in its operating system or application execution environment, the procedure for automatically generating the code remains the same.

The code provider C still provides code that is more customized to the individual applications (for example the function: Log—Which—Golf—Club, mentioned earlier) by providing wrappers to the function General—Log—Event. This will make the functions easier to use for the application developer and will mitigate the potential for mistakes.

The only difference in the implementation in this code is already resident on the cellular telephone is that the body of the function General—Log—Event may not need to be shipped to the application developer, since this will already be resident on the device. Instead, the function: Log—Which—Golf—Club will simply call the device resident functions such as General—Log—Event.

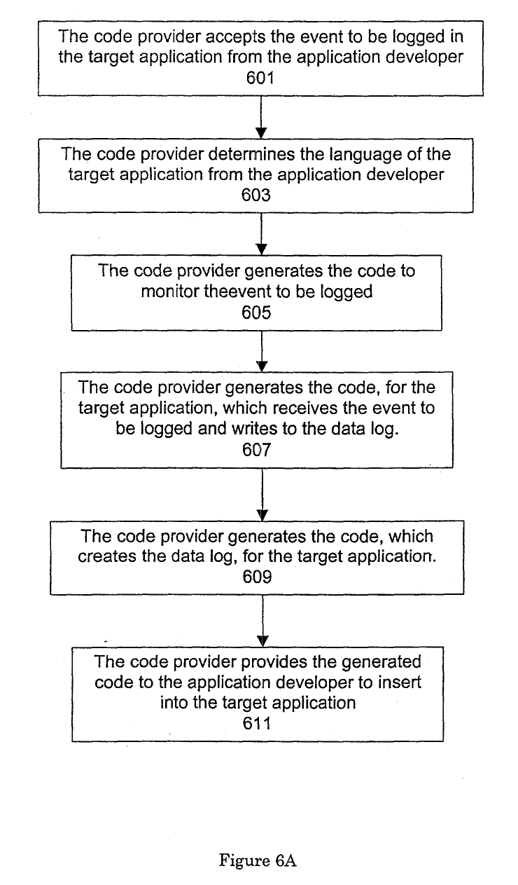

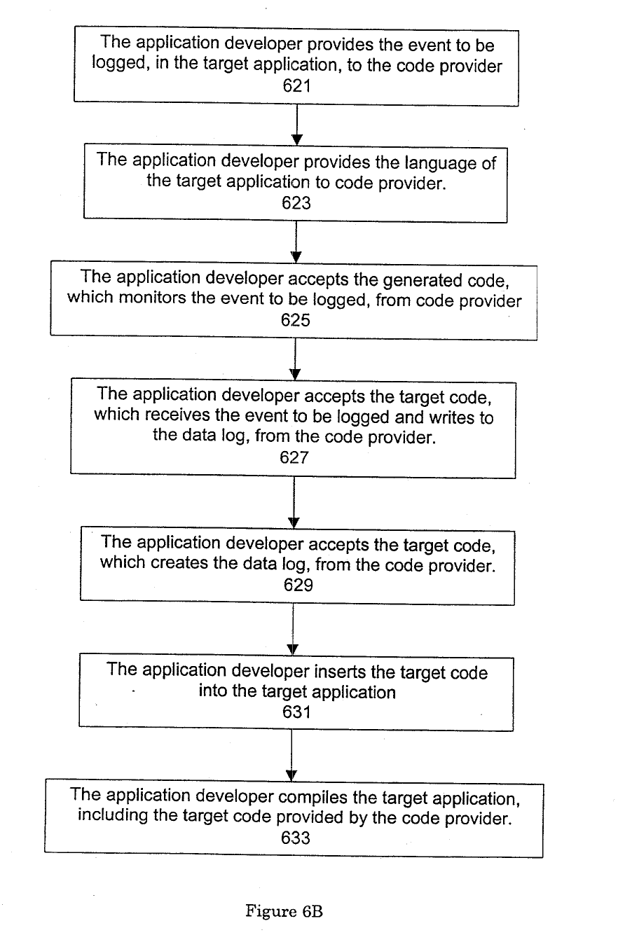

FIG. 6A is a flow diagram illustrating the process by which the code provider provides target code to an application developer. The specific example used is that of providing data logging code as illustrated in FIG. 3, but the process may be extended to providing any type of target code. In block 601 the code provider accepts an event to be logged in the target application. In block 603 the code provider then determines the target language from the application developer. In block 605 the code provider generates the code to monitor the event to be logged. In block 607 the code provider generates the code which receives the event to be logged and writes it to the data log 307 (See FIG. 3). In block 609 the code provider generates the target code which creates the data log in the target application. If the data log is already present the block 609 may not be needed. If it is not known whether the data log is present the target code of the block 609 may include a code segment that tests for the presence of the data log and creates the data log if none is present. In block 611 the code provider provides the generated code to the application developer to insert into the target application.

FIG. 6B is a flow diagram illustrating the process by which the application developer receives the target code from the code provider. The specific example used is that of receiving the data logging code, but the process is applicable to providing any type of target code. In block 621 the application developer provides the event to be logged, in the target application, to the code provider. In block 623 the application developer provides the language of the target application to the code provider. Once the code provider receives the language of the target application and the event to be monitored the code provider may generate the code to monitor the event. In block 625 the application developer accepts the event monitoring code generated by the code provider. In block 627 the application developer accepts target code, which receives the event to be logged and writes the event to be logged to the data log 307, from the code provider. In block 629 the application developer accepts code, which creates the data log, from the code provider. If the data log is present, the application developer may not need to receive code that generates the data log from the code provider and hence the block 629 will not be required. Once the application developer has received the requisite target code the application developer can include it in the application program as illustrated in block 631. If the application developer is developing the application in a compiled or assembled language, then, once the target code has been inserted into the application, the application developer can compile or assemble the application as illustrated in block 633. If the application is not written in a language that is compiled or assembled the block 633 will be unnecessary.

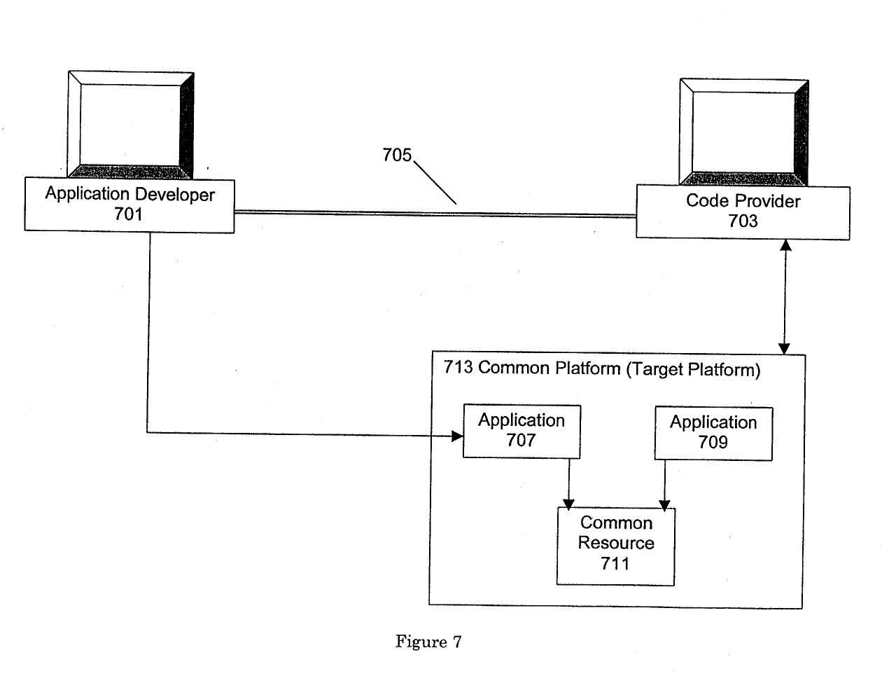

FIG. 7 is a graphical illustration of an exemplary application developer 701-code provider 703 arrangement. In FIG. 7 the application developer 701 develops an application 707 that will run on a common platform 713. Application 709 will also run on the common platform 713. Both the application 707 and the application 709 will access a common resource 711. The code provider 703 is aware of the common platform 713, which is the target platform that the target code will be developed for, the application 709, the common resource 711 and the application 707. The application developer 701 knows that application 707 will access the common resource 711. When the application developer 701 encounters an event that needs code, for the application 707, that will access the common resource 711 the application developer 701 provides that event to a code provider, for example over a link 705. Link 705 may be an Internet link or may symbolize any other link mechanism know in the art, such as exchange of files on a floppy disk, a phone connection, etc. The code provider 703 produces harmonized code for the event that accesses the common resource 711 and provides it to the application developer who inserts the code for the event into the application 707. The harmonized code is code that takes into account other applications' (for example the application 709) access to the common resource 711, and harmonizes it so that the use of the common resource 711 by multiple applications will not interfere with each other. Such harmonization of code for multiple applications may be by many methods known in the art, for example, by applying a software lock to the common resource 711, and ensuring that any identifiers that may be used to distinguish events are unique. This ensures that their operations to the common resource 711 are correctly identified.

Those skilled in the art will appreciate that the various illustrative logic blocks, components, modules, circuits, and algorithms described in connection with the embodiments disclosed herein may be implemented as electronic hardware, computer software, or combinations of both. To emphasize the interchangeability of hardware and software in the described exemplary embodiments, the various illustrative logic blocks, components, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, components, modules, and circuits described in connection with the exemplary embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, state machine or any form of digital logic. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the exemplary embodiments is provided to enable any person skilled in the art to make or use the present invention. Various modifications to these embodiments will be readily apparent to those skilled in the art, and the generic principles defined herein may be applied to construct other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of automated code generation, comprising:
identifying an event related to the execution of an application;
generating code related to the event using an automated process; and
integrating the code into the application.

2. The method of claim 1 wherein the identification of the event is performed at a first site and the generation of the code relating to the event is performed at a second site remote from the first site.

3. The method of claim 2 wherein the integration of the code into the application is performed at the first site.

4. The method of claim 1 further comprising specifying a language, and wherein the code is generated in the specified language.

5. The method of claim 1 wherein the code relates to a data logging function responsive to the event.

6. The method of claim 5 wherein the data logging function comprises generating data in response to the event and writing the data to a data log.

7. The method of claim 5 wherein the data logging function further comprises transmitting the data from the data log to a remote site.

8. The method of claim 7 wherein the data logging function further comprises formatting the data and controlling the timing of the transmission of the formatted data to the remote site.

9. The method of claim 7 wherein the data logging function further comprises deleting the data log after the data therefrom is transmitted to the remote site.

10. The method of claim 5 wherein the data logging function further comprises creating the data log.

11. The method of claim 5 wherein the application is supported by an application execution environment having a plurality of functions, and wherein the data logging function uses at least one of the functions from the application execution environment.

12. The method of claim 1 further comprising compiling, linking or calling the application with the code integrated therein.

13. The method of claim 9 further comprising executing the application.

14. The method of claim 1 wherein the code generation comprises generating a function, and customizing the function based on a parameter using the automated process.

15. The method of claim 14 wherein the parameter comprises the event.

16. The method of claim 14 wherein the customized function relates to a data logging function in response to the event.

17. The method of claim 16 further comprising executing the application including calling the customized function to perform the data logging function in response to the event.

18. Computer readable media embodying a program of instructions executable by a computer to perform a method automated code generation, the method comprising:
receiving an event related to the execution of an application; and
generating code related to the event using an automated process for integration into the application.

19. The computer readable media of claim 18 wherein the method further comprising receiving a specified language, and wherein the code is generated in the specified language.

20. The computer readable media of claim 18 wherein the code relates to a data logging function responsive to the event.

21. The computer readable media of claim 20 wherein the data logging function comprises generating data in response to the event and writing the data to a data log.

22. The computer readable media of claim 20 wherein the data logging function further comprises transmitting the data from the data log to a remote site.

23. The computer readable media of claim 22 wherein the data logging function further comprises formatting the data and controlling the timing of the transmission of the formatted data to the remote site.

24. The computer readable media of claim 22 wherein the data logging function further comprises deleting the data log after the data therefrom is transmitted to the remote site.

25. The computer readable media of claim 20 wherein the data logging function further comprises creating the data log.

26. The computer readable media of claim 20 wherein the code is generated to operate with at least one of a plurality of functions resident in an application execution environment to perform the data logging function.

27. The computer readable media of claim 18 wherein the code generation comprises generating a function, and customizing the function based on a parameter using the automated process.

28. The computer readable media of claim 27 wherein the parameter comprises the event.

29. The computer readable media of claim 27 wherein the customized function relates to a data logging function in response to the event.

30. The computer readable media of claim 29 wherein the code is configured to allow the application to call the customized function to perform the data logging function in response to the event.

31. A system for automatic code generation, comprising:
event identifier means for identifying an event related to the execution of an application;
code generation means for generating code related to the event using an automated process; and
code integration means for integrating the code into the application.

32. The system of claim 31 wherein the event identifier means resides at a first site and the code generation means resides at a second site remote from the first site.

33. The system of claim 32 wherein the code integration means resides at the first site.

34. The system of claim 31 further comprising means for specifying a language, and wherein the code generation means comprises means for generating the code in the specified language.

35. The system of claim 31 wherein the code relates to a data logging function responsive to the event.

36. The system of claim 35 wherein the data logging function comprises generating data in response to the event and writing the data to a data log.

37. The system of claim 36 wherein the data logging function further comprises transmitting the data from the data log to a remote site.

38. The system of claim 37 wherein the data logging function further comprises formatting the data and controlling the timing of the transmission of the formatted data to the remote site.

39. The system of claim 37 wherein the data logging function further comprises deleting the data log after the data therefrom is transmitted to the remote site.

40. The system of claim 35 wherein the data logging function further comprises creating the data log.

41. The system of claim 35 wherein the application is supported by an application execution environment having a plurality of functions, and wherein the data logging function uses at least one of the functions from the application execution environment.

42. The system of claim 31 further comprising means for compiling, linking or calling the application with the code integrated therein.

43. The system of claim 42 further comprising means for executing the application.

44. The system of claim 31 wherein the code generation means comprises means for generating a function, and means for customizing the function based on a parameter using the automated process.

45. The system of claim 44 wherein the parameter comprises the event.

46. The system of claim 44 wherein the customized function relates to a data logging function in response to the event.

47. The system of claim 46 further comprising means for executing the application including means for calling the customized function to perform the data logging function in response to the event.
